(19) United States
(12) Patent Application Publication
(10) Pub. No.: US 2005/0099066 A1
(43) Pub. Date: May 12, 2005

(54) Device for controlling multi-stage or dual igniter airbags in motor vehicles

(76) Inventor: Robert Netherton Brown JR., Frederick, MD (US)

Correspondence Address: Robert Netherton Brown, Jr., 7301 Brookside Drive, Frederick, MD, 21702, US

(21) Appl. No.: 10/703,050

(22) Filed: Nov. 6, 2003

(51) Int. Cl. B60L 1/00

(52) U.S. Cl. 307/10.1

(57) ABSTRACT

A device for controlling a multi-stage or dual igniter airbag in motor vehicles having a common bypass circuit which only contains one resistor for use by multiple circuits within an airbag switch simultaneously. The preferred embodiment includes use of one or more additional circuits attached to a fourth or subsequent pole of the switch mechanism to allow the device to communicate its status to other components and systems in the vehicle.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of passenger motor vehicles and more specifically to a device for controlling multi-stage or dual igniter airbags in motor vehicles.

Originally airbags were developed with a single detonation circuit, but the force required for an airbag to stop an occupant in the event of an accident was excessive, and resulted in many injuries and deaths; most from low speed accidents. Since 2000, airbag systems have come into use that include a multi-stage airbag to help reduce the force of airbag detonation in low speed accidents, with the intention of making airbag detonation safer for a vehicle's occupants.

In recent years, vehicles have been manufactured with Crash Data Recorders (also called “Black Boxes”) and equipped with systems such as Onstar allowing remote monitoring of the vehicle. These systems gather information from the vehicle continuously and communicate it either to a recorder in the vehicle or to another location. Once an airbag switch is installed, though, there is no way for the vehicle to sense if the airbag is turned off, as required by the federal regulations governing airbag switches.

Originally, a single stage airbag switch patent was awarded, and was intended to control a single stage airbag; turning it on or off depending on the preferences of the vehicle's occupant. Dual igniter airbags were introduced by some manufacturers in which there were two detonators. Patents were awarded for an airbag switch that simply put two of these single airbag switch circuits into one airbag switch box so that it could be used to manually control an airbag with two detonators such as a dual igniter airbag or a multistage airbag.

These airbag switches were developed to satisfy the minimum requirements mandated in the Federal Motor Vehicle Safety Standard (FMVSS No. 208, Occupant Crash Protection).

Previous airbag switches did not address the need to communicate with other devices. Multi-stage airbag switches also used separate resistors and fuses for each bypass circuit increasing cost and potential incidence of errors in manufacture, and also rendering the airbag switch useless to perform its required function once it had passed a detonation charge in the “Airbag Off” position, and the fuse had interupted the bypass circuit. This made it necessary to replace the entire airbag switch once a detonation impulse passed through the bypass circuits.

This invention includes only on resistor common to all bypass circuits, and no fuses. In addition, it includes features that will provide for communication between the airbag switch and other devices in the vehicle.

### BRIEF SUMMARY OF THE INVENTION

The primary object of the invention is To provide a multi-stage airbag switch, that requires fewer parts in order to perform its basic functions.

Another object of the invention is To provide a novel electronic circuit that also has improved potential to interface with other devices in a motor vehicle, such as Onstar or the vehicle's Crash Data Recorder or the vehicle's SRS System.

A further object of the invention is to provide an airbag switch with longer life and that does not have to be replaced each time a detonation current passes through the bypass circuit.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a device for controlling a multi-stage or dual igniter airbag in motor vehicles comprising: A bypass circuit which only contains one common resistor for simultaneous use by multiple circuits within an airbag switch, and The use of one or more additional circuits to allow the device to communicate its status to other components and systems in the vehicle.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the airbag switch box.

FIG. 2 is an electrical schematic of the circuit embodied in the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

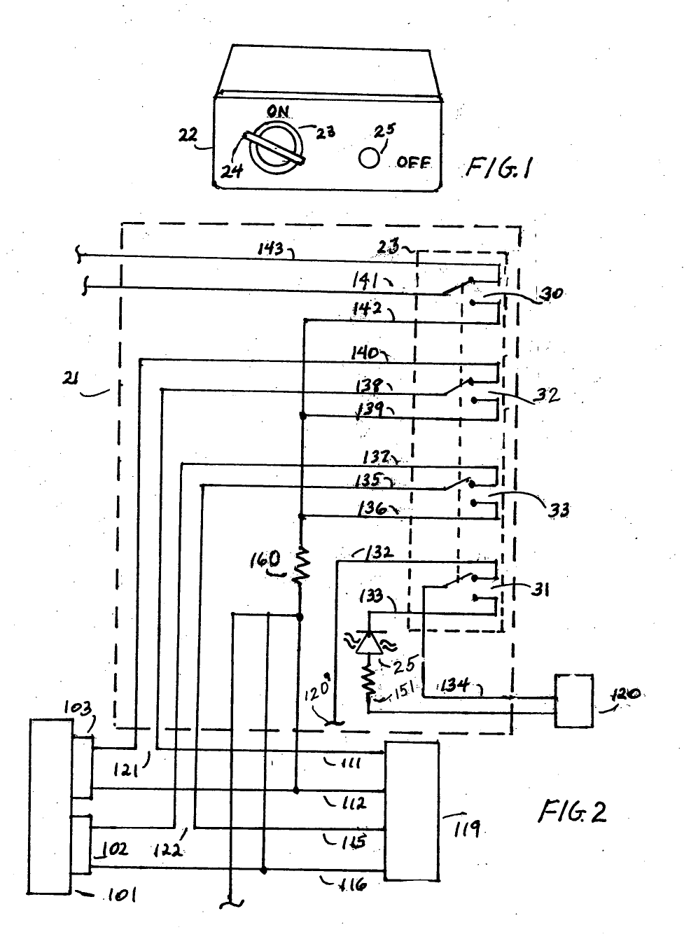

Turning first to FIG. 1 there is shown a device for controlling the deployment of a multistage airbag in a motor vehicle. The device has a rectangular housing 22 with a two position (“on and off”) key-operated switch 23 on the front face. A removable key 24 is provided for actuating the switch mechanism 23. The device includes one light emitting diode (LED) 25 for visual confirmation of the switch position selected. When the airbag is turned off, the LED 25 is illuminated as long as the vehicle's ignition is turned on. When the airbag is active there is no light. The exterior case of the switch includes lettering to indicate whether the airbag is active or disconnected.

Turning to FIG. 2, an electrical diagram for connecting switch device 21 to a multi stage airbag module 101 having two ignitors 102, 103 is shown. Typically, a sensor in the vehicle will determine the severity of the impact of the vehicle during an accident. If the impact is less severe, only one of the igniters 102 or 103 ignites to inflate airbag 101. If the impact is more severe, both igniters 102, 103 ignite to inflate the airbag 101. Each igniter is conneced through a pair of wires 111, 112 and 115, 116 respectively to the vehicle's airbag controller 119, which monitors and controls the operation of the vehicle's Supplemental Restraint System, among other functions, including the airbag module 101 and its igniters 102,103. Without device 21, the airbag controller would be connected directly to the airbag through wires 111, 112 and 115, 116. However, with device 21, wires 111 and 115 are interruted at breaks 121 and 122, repectively and connected to device 21.

In the embodiment shown in FIG. 2, switch 23 is a four-pole, double-throw switch. Switch 23 has a first pole 31 connected with wire 133 to the LED 150 and its resistor 151 and then to an external power source 120 in the vehicle and connected externally to the vehicle's ground 120 through wire 134. The preferred embodiment is shown which comprises multiple circuits simultaneously switched by the keyed four pole switch for controlling dual igniter airbags in motor vehicles. The device comprises multiple bypass circuits to control each of the airbag's igniters, however each bypass circuit shares only one, common resistor 160. The device also contains a separate circuit to indicate the status of the airbag by illuminating the LED 25 when the airbag is turned off, as long as the vehicle's ignition is On.

One feature of the invention is the inclusion of a fourth circuit within the device, also simultaneously controlled by the fourth pole of the switch mechanism 141. This fourth circuit can be used for multiple purposes including enabling the device to communicate the switch status to other components and systems in the vehicle, such as Onstar, the SRS System and the Crash Data Recorder, or being used to control a third stage of an airbag or a separate one-stage airbag in the vehicle such as a side airbag.

In operation, device 21 may be turned off to prevent the airbag module 101 from deploying in the event of a collision, or turned on to allow module 101 to deploy. When device 21 is “On” (FIG. 2), poles 30, 31, 32, and 33 are simultaneously thrown or actuated to the upper position, this allows the circuit to be completed between the vehicle's airbag controller, 119 and the airbag 101 through wires 138, 140 and 135, 137. At the same time, pole 131 connects to the terminal for wire 132, so that the L.E.D. 25 is not illuminated.

When device 21 is “Off” (not shown), poles 30, 31, 32, and 33 are simultaneously thrown to the lower position. This interrupts the circuit between the vehicle's airbag controller 119 and the airbag 101 at breaks 121 and 122. This connects wires 135, 138 and 141 to the bypass circuit wires 136,139 and 142 respectively, which pass through the common bypasss resistor 160 and back into the airbag detonation circuit. In effect, this shunts bypass resistor 160 between wires 111 and 112, between wires 115 and 116, and between any external circuit connected to wires 142 and 141. Pole 31 simultaneously activates the LED 25 to emit a yellow light to indicate that the airbag is turned “Off” and will not deploy.

While the invention has been described in only one of its forms, it should be apparent to those skilled in the art that it is not so limited, but is suceptible to various changes without departing from the scope of the invention. For example, the device shown has an additional circuit that may be used for communication with other devices in the vehicle or to control a separate single stage airbag or a three stage airbag. The device shown and described could be configured for more airbag modules by adding more poles and bypass circuits connected to use the on bypass resistor 160. Another embodiment may include diodes in the circuit to reduce the possiblility of addicental detonation by inductive reactance, from sources such as radio waves.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A device for controlling a multi-stage or dual igniter airbag in motor vehicles comprising:
A common bypass circuit which only contains one resistor for use by multiple circuits within an airbag switch simultaneously; and
The use of one or more additional circuits to allow the device to communicate its status to other components and systems in the vehicle.
